(19) United States
(12) Patent Application Publication
(10) Pub. No.: US 2018/0272224 A1
(43) Pub. Date: Sep. 27, 2018

(54) INTELLIGENT BASEBALL DEVICE AND HELMET AND METHOD FOR ASSISTING IN JUDGING STRIKE

(71) Applicant: BOE TECHNOLOGY GROUP CO., LTD., Beijing (CN)

(72) Inventors: Shuo CHEN, Beijing (CN); Jibo Zhao, Beijing (CN)

(21) Appl. No.: 15/788,290

(22) Filed: Oct. 19, 2017

(30) Foreign Application Priority Data
Mar. 27, 2017 (CN) 201710189066.3

(51) Int. Cl. A63B 71/06; A42B 3/04; A63B 69/00; G06T 19/00; G02B 27/01

(52) U.S. Cl. CPC A63B 71/0605; A42B 3/04; A63B 71/0622; A63B 69/0002; G06K 9/00664; G02B 27/0172; A63B 2071/0666; A63B 2220/806; G06T 2207/10028; G06T 19/006

(57) ABSTRACT

An intelligent baseball device, an intelligent baseball helmet and a method for assisting in judging a strike are provided. The intelligent baseball device includes a depth camera, a display device and a processing unit. The depth camera is communicated with the processing unit; and the processing unit is configured to extract feature information of a home plate and feature information of a batter from a depth image acquired by the depth camera and create a real-time strike zone 3D model. The display device is communicated with the processing unit; the processing unit is configured to send a display signal of a real-time strike zone 3D model to the display device; and the display device displays the real-time strike zone 3D model according to the display signal of the real-time strike zone 3D model.

### CROSS-REFERENCES TO RELATED APPLICATIONS

The application claims priority to the Chinese patent application No. 201710189066.3, filed on Mar. 27, 2017 with SIPO and entitled “Intelligent Baseball Device and Helmet and Method for Assisting in Judging Strike”, which is incorporated herein by reference in its entirety

### TECHNICAL FIELD

Embodiments of the present disclosure relate to an intelligent baseball device, an intelligent baseball helmet, and a method for assisting in judging a strike.

### BACKGROUND

Baseball is a ball game having the main characteristic of adopting a bat to strike a ball and having strong communality and opposability, and is popular sports game in the world.

In baseball, the speed per hour of a ball pitched by a bowler is high (for example, in a professional game, the speed per hour of the baseball pitched by a bowler is more than 130 km/h), and the baseball has large mass, so the baseball has high kinetic energy. Therefore, in addition to leg guard, arm guard, gloves and other protective equipment, the catcher and the umpire also wear a protective helmet to prevent the face from being injured by the baseball.

### SUMMARY

At least one embodiment of the present disclosure provides an intelligent baseball device, an intelligent baseball helmet, and a method for assisting in judging a strike.

At least one embodiment of the present disclosure provides an intelligent baseball device, comprising: a depth camera configured to acquire a depth image of a home plate and a batter; a display device configured to display an image according to a display signal; and a processing unit. The depth camera is communicated with the processing unit. The processing unit is configured to extract feature information of the home plate and feature information of the batter from the depth image and create a real-time strike zone 3D model. The display device is communicated with the processing unit. The processing unit is configured to send a display signal of the real-time strike zone 3D model to the display device. The display device displays the real-time strike zone 3D model according to the display signal of the real-time strike zone 3D model.

For example, in an intelligent baseball device provided in an example of the embodiment, the processing unit is also configured to calculate the relative positional relationship between the display device and the home plate, and map the relative positional relationship into the real-time strike zone 3D model, to allow a virtual image of the real-time strike zone 3D model to be located over the home plate.

For example, in an intelligent baseball device provided in an example of the embodiment, the display device includes a transparent display device.

For example, in an intelligent baseball device provided in an example of the embodiment, the display device includes: a transflective member; and a projector. The projector is configured to project the real-time strike zone 3D model onto the transflective member according to the display signal of the real-time strike zone 3D model. The transflective member is configured to reflect the real-time strike zone 3D model.

For example, in an intelligent baseball device provided in an example of the embodiment, the transflective member includes semi-transmissive glasses.

For example, in an intelligent baseball device provided in an example of the embodiment, the depth camera is also configured to acquire an image of a realistic scene. The processing unit is configured to process the image of the realistic scene to be a first layer, and acquire position information of the home plate and the batter in the first layer, position the real-time strike zone 3D model according to the position information of the home plate and the batter in the first layer and form a second layer. The display device is configured to simultaneously display the first layer and the second layer, to allow the virtual image of the real-time strike zone 3D model to be located over the home plate.

For example, in an intelligent baseball device provided in an example of the embodiment, the second layer has a transparency in a range of 10%-90%.

For example, in an intelligent baseball device provided in an example of the embodiment, the processing unit includes: an image processing unit configured to process the depth image, and extract the feature information of the home plate and the feature information of the batter from the depth image; a model storage unit configured to store a standard 3D model; and a model generation unit configured to map the feature information of the home plate and the feature information of the batter onto the standard 3D model to create the real-time strike zone 3D model.

For example, in an intelligent baseball device provided in an example of the embodiment, the feature information of the home plate includes position information of five vertexes of the home plate.

For example, in an intelligent baseball device provided in an example of the embodiment, the feature information of the batter includes position information of the shoulder joint and the knee joint of the batter.

At least one embodiment of the present disclosure provides an intelligent baseball helmet, comprising: a helmet body; and an intelligent baseball device disposed on the helmet body. The intelligent baseball device includes the intelligent baseball device.

At least one embodiment of the present disclosure provides a method for assisting in judging a strike, comprising: acquiring a depth image of a home plate and a batter; extracting feature information of the home plate and feature information of the batter from the depth image; creating a real-time strike zone 3D model according to the feature information of the home plate and the feature information of the batter; displaying the real-time strike zone 3D model and allowing a virtual image of the real-time strike zone 3D model to be located over the home plate; and determining whether a pitch is a strike when the pitched ball passes through the virtual image of the real-time strike zone 3D model.

In a method for assisting in judging a strike provided in an example of the embodiment, the displaying of the real-time strike zone 3D model and allowing the virtual image of the real-time strike zone 3D model to be located over the home plate includes: acquiring the relative positional relationship between the display device and the home plate; and mapping the relative positional relationship into the real-time strike zone 3D model so as to form the virtual image of the real-time strike zone 3D model over the home plate.

In a method for assisting in judging a strike provided in an example of the embodiment, the displaying of the real-time strike zone 3D model and allowing the virtual image of the real-time strike zone 3D model to be located over the home plate includes: acquiring an image of a realistic scene to be a first layer; acquiring position information of the home plate and the batter in the first layer; positioning the real-time strike zone 3D model according to the position information of the home plate and the batter in the first layer, and forming a second layer; and simultaneously displaying the first layer and the second layer so as to form the virtual image of the real-time strike zone 3D model over the home plate.

In a method for assisting in judging a strike provided in an example of the embodiment, the simultaneously displaying of the first layer and the second layer includes: setting the transparency of the second layer to be 10%-90%.

### BRIEF DESCRIPTION OF THE DRAWINGS

In order to demonstrate clearly technical solutions of the embodiments of the present disclosure, the accompanying drawings in relevant embodiments of the present disclosure will be introduced briefly. It is apparent that the drawings may only relate to some embodiments of the present disclosure and not intended to limit the present disclosure.

FIG. 1 is a schematic diagram of a baseball sport;

FIG. 2 is a schematic diagram of an intelligent baseball device provided by an embodiment of the present disclosure;

FIG. 3 is a schematic diagram illustrating the operation of the intelligent baseball device provided by an embodiment of the present disclosure;

FIG. 4 is a schematic structural view of a display device provided by an embodiment of the present disclosure;

FIG. 5 is a schematic diagram of a processing unit in an embodiment of the present disclosure;

FIG. 6 is a schematic diagram illustrating the process of creating a real-time strike zone 3D model in an embodiment of the present disclosure;

FIG. 7 is a schematic structural view of an intelligent baseball helmet provided by an embodiment of the present disclosure; and

FIG. 8 is a flow diagram of a method for assisting in judging a strike provided by an embodiment of the present disclosure.

### DETAILED DESCRIPTION

In order to make objects, technical details and advantages of the embodiments of the disclosure apparent, the technical solutions according to the embodiments of the present disclosure will be described clearly and understandable as below in conjunction with the accompanying drawings of embodiments of the present disclosure. It is apparent that the described embodiments are only a part of but not all of exemplary embodiments of the present disclosure. Based on the described embodiments of the present disclosure, various other embodiments can be obtained by those of ordinary skill in the art without creative labor and those embodiments shall fall into the scope of the present disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present application, are not intended to indicate any sequence, amount or importance, but for distinguishing various components. Also, the terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly.

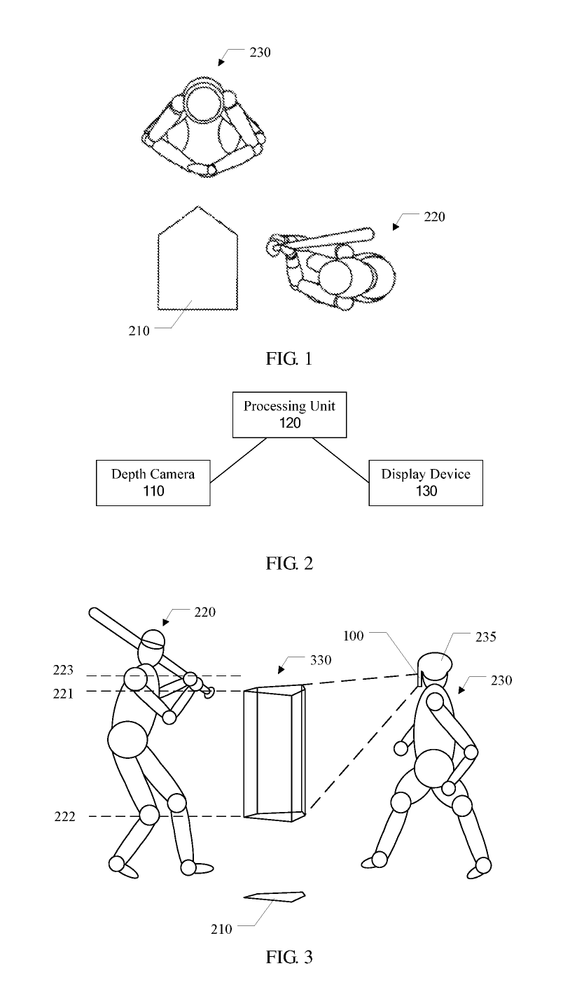

In baseball, as shown in FIG. 1, an umpire 230 may determine whether a ball pitched by a bowler is a strike according to positions of a home plate 210 and a batter 220. According to the conventional baseball rule, when a pitched ball is located in an area of the home plate and between the armpit and the knee of the batter, the pitch is a strike. However, as the speed of the pitched baseball is fast (for instance, in a professional game, the speed per hour of the baseball pitched by the bowler is more than 130 km/h), on one hand, there is high requirement for the umpire to judge whether a pitch is a strike, which is unfavorable for the promotion of the baseball sport; and on the other hand, even a good umpire cannot avoid misjudgment, so as to cause irreversible loss in an official game. Therefore, the inventor of the application thought of designing an intelligent baseball device to assist the umpire in judging whether a pitch is a strike.

Embodiments of the present disclosure provide an intelligent baseball device, an intelligent baseball helmet and a method for assisting in judging a strike. The intelligent baseball device may comprise a depth camera, a display device, and a processing unit. The depth camera can acquire a depth image of a home plate and a batter. The display device can display an image according to a display signal. The depth camera is communicated with the processing unit; and the processing unit may extract feature information of the home plate and feature information of the batter from the depth image and create a real-time strike zone 3D model. The display device is communicated with the processing unit; the processing unit is configured to send a display signal of the real-time strike zone 3D model to the display device; and the display device displays the real-time strike zone 3D model according to the display signal of the real-time strike zone 3D model. In this way, the intelligent baseball device can realize the augmented reality (AR) between the real-time strike zone 3D model and a realistic scene; and the umpire can see the virtual real-time strike zone 3D model over the real home plate through the intelligent baseball device, and can determine that a pitch is a strike when the pitched ball passes through the real-time strike zone 3D model. In this way, the intelligent baseball device can decrease the difficulty in judging whether a pitch is a strike, or not, and reduce the possibility of misjudgment.

Description will be given below to the intelligent baseball device, the intelligent baseball helmet and the method for assisting in judging a strike, provided by embodiments of the present disclosure, with reference to the accompanying drawings.

### First Embodiment

The embodiment provides an intelligent baseball device. FIG. 2 is a schematic diagram of an intelligent baseball device. As illustrated in FIG. 2, the intelligent baseball device comprises a depth camera 110, a display device 130 and a processing unit 120. The depth camera 110 may acquire a depth image of a home plate and a batter. The display device 130 may display an image according to a display signal. The depth camera 110 is communicated with the processing unit 120; and the processing unit 120 may extract feature information of a home plate (for instance, position information of five vertexes of the home plate) and feature information of a batter (for instance, height information of the knee joint/articulatio genus and the shoulder joint/articulatio humeri of the batter) from the depth image and create a real-time strike zone 3D model. The display device 130 is communicated with the processing unit 120; the processing unit 120 may send a display signal of the real-time strike zone 3D model to the display device 130; and the display device 130 displays the real-time strike zone 3D model according to the display signal of the real-time strike zone 3D model. It should be noted that the depth image may be also referred to as range image, and refers to an image of distance (depth) from the depth camera to points in a captured scene. The real-time strike zone 3D model refers to that a strike zone 3D model will be refreshed or rebuilt according to the feature information of the home plate and the feature information of the batter. For instance, the depth camera may acquire the depth image of the home plate and the batter for at least 24 times per minute, and the processing unit at least creates the real-time strike zone 3D model for 24 times per minute. In addition, the specific shape and the size of the real-time strike zone 3D model can be set according to the rules in the baseball sport.

In the intelligent baseball device provided by the embodiment, the processing unit may extract the feature information of the home plate (for instance, the position information of the five vertexes of the home plate) and the feature information of the batter (for instance, the height information of the shoulder joint and the knee joint of the batter) from the depth image acquired by the depth camera, create the real-time strike zone 3D model according to the feature information of the home plate and the feature information of the batter, and send the display signal of the real-time strike zone 3D model to the display device; and the display device displays the real-time strike zone 3D model according to the display signal. The intelligent baseball device can realize the AR between the real-time strike zone 3D model and a realistic scene; and the umpire can see a virtual image of the real-time strike zone 3D model over the real home plate by the intelligent baseball device, and can determine that a pitch is a strike when the pitched ball passes through the virtual image of the real-time strike zone 3D model. In this way, the intelligent baseball device can reduce the difficulty in judging whether a pitch is a strike, and reduce the possibility of misjudgment. It should be noted that the virtual image of the real-time strike zone 3D model refers to a virtual image of the real-time strike zone 3D model displayed on the display device in the eyes of a user using the intelligent baseball device.

For instance, in the intelligent baseball device provided by an example of the embodiment, the feature information of the home plate includes position information of five vertexes of the home plate. For instance, a bottom surface and a top surface of the real-time strike zone 3D model may be created or limited according to the position information of the five vertexes of the home plate.

For instance, in the intelligent baseball device provided by an example of the embodiment, the feature information of the batter includes position information of the shoulder joint and the knee joint of the batter. In baseball sport, the position of a strike zone is over the home plate and between the knee joint and the armpit of the batter. As position information of the armpit of the batter is difficult to acquire and the shoulder joint is easy to identify, the embodiment may acquire and calculate the position information of the shoulder joint to obtain the position of the armpit of the batter. For instance, the height information of the armpit of the batter may be obtained by the height information of the shoulder joint minus the size of the shoulder joint in the vertical direction, e.g., 15 cm. The embodiments of the present disclosure include but are not limited thereto, and the height information of the armpit of the batter may be directly acquired.

FIG. 3 is a schematic diagram illustrating the operation principle of the intelligent baseball device. As shown in FIG. 3, the umpire 230 may wear an intelligent baseball device 100, for instance, the intelligent baseball device 100 is hung on a protective helmet 235 or directly integrated into the protective helmet 235. The depth camera in the intelligent baseball device 100 acquires a depth image of a home plate 210 and a batter 220. The processing unit in the intelligent baseball device 100 may extract feature information of the home plate 210, e.g., position information of five vertexes of the home plate, and feature information of the batter 220, e.g., the height information of the knee joint and the shoulder joint of the batter, from the depth image acquired by the depth camera, create a real-time strike zone 3D model according to the feature information of the home plate 210 and the feature information of the batter 220, and send a display signal of the real-time strike zone 3D model to the display device. For instance, a bottom surface and/or a top surface of the real-time strike zone 3D model may be determined according to the position information of the five vertexes of the home plate; height information of the knee joint 222 and the armpit 221 of the batter may be determined according to the height information of the knee joint 222 and the shoulder joint 223 of the batter; and the height of the real-time strike zone 3D model and the distance from the ground may be determined. The display device in the intelligent baseball device 100 may display the real-time strike zone 3D model, and a virtual image 330 of the real-time strike zone 3D model may be located/shown over the home plate 210 and between the knee joint 222 and the armpit 221 of the batter 220, namely the bottom surface of the real-time strike zone 3D model and the knee joint are in a same plane parallel to the ground. The umpire 230 may see the virtual image 330 of the real-time strike zone 3D model over the real home plate 210 through the intelligent baseball device 100, and may determine that a pitch is a strike when the pitched ball passes through the virtual image 330 of the real-time strike zone 3D model. It should be noted that the user may adjust own position according to the real-time strike zone 3D model displayed on the display device, so that the virtual image of the real-time strike zone 3D model can be located over the home plate. The embodiments of the present disclosure include but are not limited thereto.

For instance, in the intelligent baseball device provided by an example of the embodiment, the processing unit may also calculate the relative positional relationship between the display device and the home plate, and map the relative positional relationship into the real-time strike zone 3D model, so that the virtual image of the real-time strike zone 3D model can be located/shown over the home plate. For instance, when the intelligent baseball device is fixed on the protective helmet of the umpire or integrated onto the protective helmet of the umpire, the positional relationships among the depth camera and the display device and the eyes of the umpire are fixed values and may be prestored into the intelligent baseball device; the processing unit may calculate the positional relationship between the display device and the eyes of the umpire and the relative positional relationship between the display device and the home plate according to the feature information of the home plate and the positional relationships among the depth camera and the display device and the eyes of the umpire, map the positional relationship between the display device and the eyes of the umpire and the relative positional relationship between the display device and the home plate into the real-time strike zone 3D model, and determine the size and the position of the real-time strike zone 3D model on the display device, so that the virtual image of the real-time strike zone 3D model in the eyes of the umpire can be located over the home plate. It should be noted that the real-time strike zone 3D model is created according to the feature information of the batter, so that the virtual image of the real-time strike zone 3D model can be located between the knee joint 222 and the armpit 221 of the batter 220 according to the feature information of the batter (for instance, the height information of the knee joint of the batter).

For instance, in the intelligent baseball device provided by an example of the embodiment, the display device may include a transparent display device. That is to say, an image displayed on the display device and a realistic scene on the back of the display device may be simultaneously viewed through the display device. In this way, the user can see the virtual image of the real-time strike zone 3D model over the real home plate through the intelligent baseball device.

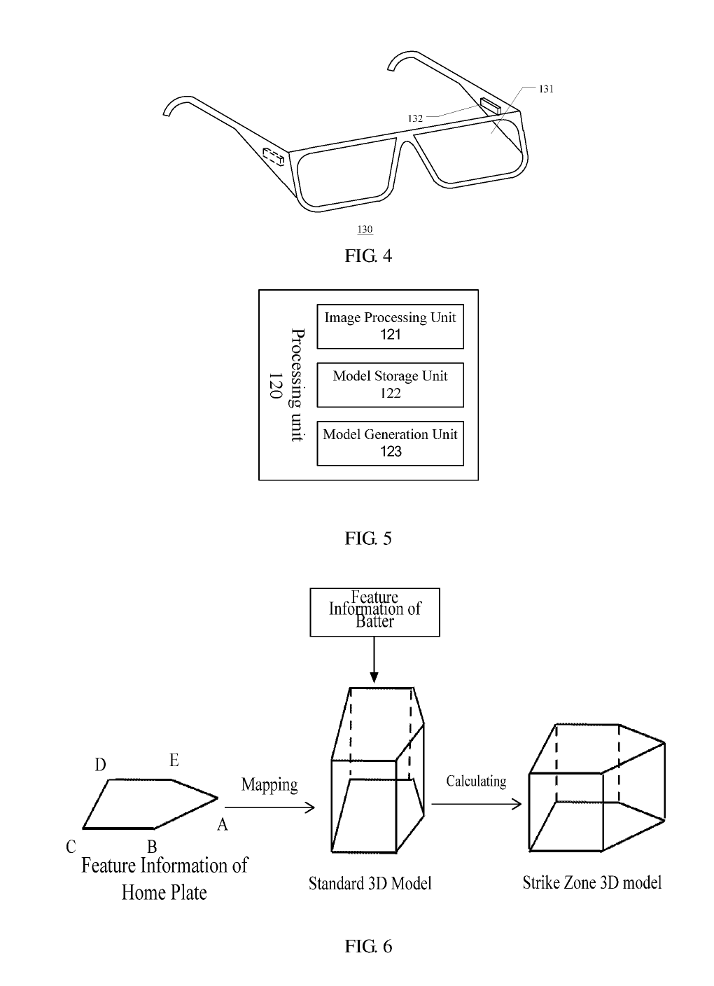

For instance, FIG. 4 is a schematic structural view of a display device. In the intelligent baseball device provided by an example of the embodiment, as shown in FIG. 4, the display device 130 may include a transflective member 131 and projector(s) 132. The projector(s) 132 may project the real-time strike zone 3D model onto the transflective member 131 according to the display signal of the real-time strike zone 3D model, and the transflective member 131 may reflect the real-time strike zone 3D model. In this way, the user may view the real-time strike zone 3D model displayed on the transflective member, and may also view the realistic scene through the transflective member.

For instance, as shown in FIG. 4, the transflective member 131 may be a pair of semi-transmissive glasses.

For instance, in the intelligent baseball device provided by an example of the embodiment, as shown in FIG. 5, a processing unit 120 includes an image processing unit 121, a model storage unit 122, and a model generation unit 123. The image processing unit 121 may process the depth image and extract the feature information of the home plate and the feature information of the batter from the depth image; the model storage unit 122 stores a standard 3D model; and the model generation unit 123 may map the feature information of the home plate and the feature information of the batter onto a standard 3D model to create a real-time strike zone 3D model.

For instance, as shown in FIG. 6, the processing unit may map the feature information of the home plate, e.g., position information of five vertexes (A, B, C, D, and E) of the home plate, and the feature information of the batter into the standard 3D model to create a real-time strike zone 3D model. For instance, the standard 3D model includes a bottom variable and a height variable and may substitute the feature information of the home plate (for instance, the position information of the five vertexes (A, B, C, D, and E)) into the bottom variable of the standard 3D model, and substitute the feature information of the batter (for instance, the height information of the knee joint and the shoulder joint of the batter) into the height variable of the standard 3D model, so as to create a real-time strike zone 3D model. The embodiments of the present disclosure include but are not limited thereto, and other ways may also be adopted to map the feature information of the home plate and the feature information of the batter into the standard 3D model to create the real-time strike zone 3D model.

The second embodiment provides an intelligent baseball device on the basis of the first embodiment. The differences from the first embodiment include: the depth camera may also acquire an image of a realistic scene; the processing unit may also process the image of the realistic scene to be a first layer, acquire position information of the home plate and the batter in the first layer, position the real-time strike zone 3D model according to the position information of the home plate and the batter in the first layer, and form a second layer; and the display device may simultaneously display the first layer and the second layer, for instance, the second layer is formed on the first layer, so that the virtual image of the real-time strike zone 3D model can be located over the home plate. In this way, the user can simultaneously see the virtual image of the realistic scene and the virtual image of the real-time strike zone 3D model through the display device. Moreover, the virtual image of the real-time strike zone 3D model is located over a virtual image of the home plate. In the embodiment, the display device may adopt a common display device and is not required to be a transparent display device, so the cost can be reduced.

For instance, in the intelligent baseball device provided by an example of the embodiment, the transparency of the second layer is ranged from 10% to 90%, to allow the first layer under the second layer to be viewed. The embodiments of the present disclosure include but are not limited thereto. The first layer may be displayed on the second layer, and the transparency of the first layer is set to be 10%-90%.

### Third Embodiment

The embodiment provides an intelligent baseball helmet, which comprises a helmet body and an intelligent baseball device. The intelligent baseball device is disposed on the helmet body. The intelligent baseball device may be the intelligent baseball device provided by any of the embodiments. As the intelligent baseball helmet comprises the intelligent baseball device provided by any of the embodiments, the intelligent baseball helmet can reduce the difficulty in judging whether a pitch is a strike, and reduce the possibility of misjudgment.

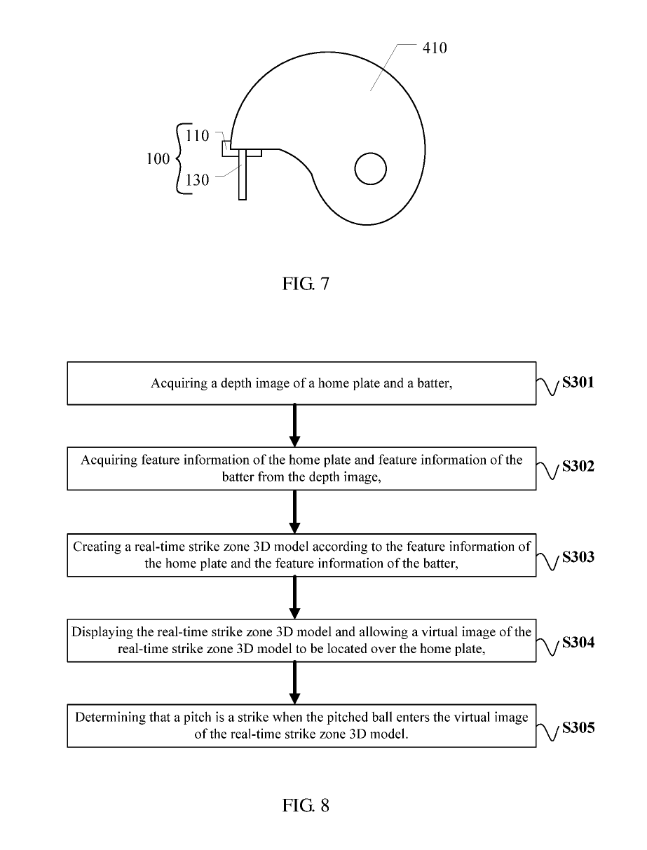

For instance, as shown in FIG. 7, the intelligent baseball helmet comprises a helmet body 410 and an intelligent baseball device 100. The intelligent baseball device 100 is disposed on the helmet body 410. The display device 130 and the depth camera 110 may be disposed between the eyes of a user and a realistic scene. It should be noted that the specific position of the processing unit in the intelligent baseball device may be set according to actual conditions. No limitation will be given here in the embodiment of the present disclosure.

### Fourth Embodiment

The embodiment provides a method for assisting in judging a strike. As shown in FIG. 8, the method comprises steps S401-S405.

S401: acquiring a depth image of a home plate and a batter.

For instance, the depth image of the home plate and the batter may be acquired through the depth camera.

S402: acquiring feature information of the home plate and feature information of the batter from the depth image.

For instance, the feature information of the home plate includes position information of five vertexes of the home plate, and the feature information of the batter includes position information of the shoulder joint and the knee joint of the batter.

S403: creating a real-time strike zone 3D model according to the feature information of the home plate and the feature information of the batter.

S404: displaying the real-time strike zone 3D model and allowing a virtual image of the real-time strike zone 3D model to be located over the home plate.

S405: determining that a pitch is a strike when the pitched ball enters the virtual image of the real-time strike zone 3D model.

In the method for assisting in judging a strike provided by the embodiment, the feature information of the home plate (for instance, the position information of the five vertexes of the home plate) and the feature information of the batter (for instance, the position information of the shoulder joint and the knee joint of the batter) may be extracted from the depth image, and the real-time strike zone 3D model is created according to the feature information of the home plate and the feature information of the batter; and the real-time strike zone 3D model is displayed to realize the AR between the real-time strike zone 3D model and the realistic scene. The umpire may see the virtual image of the real-time strike zone 3D model over the real home plate, and may determine that a pitch is a strike when the pitched ball passes through the virtual image of the real-time strike zone 3D model. In this way, the intelligent baseball device can reduce the difficulty in judging whether a pitch is a strike, and reduce the possibility of misjudgment. It should be noted that the virtual image of the real-time strike zone 3D model refers to a virtual image of the real-time strike zone 3D model displayed on the display device in the eyes of a user using the intelligent baseball device. In addition, in baseball sport, the position of a strike zone is above the home plate and between the knee joint and the armpit of the batter. As the position information of the armpit of the batter is difficult to acquire, the embodiment of the present disclosure may acquire and calculate the position information of the shoulder joint to obtain the position of the armpit of the batter.

For instance, in the method for assisting in judging a strike provided by an example of the embodiment, the step of displaying the real-time strike zone 3D model and allowing the virtual image of the real-time strike zone 3D model to be located over the home plate includes: acquiring the relative positional relationship between the display device and the home plate; and mapping the relative positional relationship into the real-time strike zone 3D model and allowing the virtual image of the real-time strike zone 3D model to be located over the home plate. In this way, the virtual image of the real-time strike zone 3D model may be formed over the home plate, which may refer to relevant description in the first embodiment specifically.

For instance, in the method for assisting in judging a strike provided by an example of the embodiment, the step of displaying the real-time strike zone 3D model and allowing the virtual image of the real-time strike zone 3D model to be located over the home plate includes: acquiring an image of a realistic image as a first layer; acquiring position information of the home plate and the batter in the first layer; positioning the real-time strike zone 3D model according to the position information of the home plate and the batter in the first layer, and forming a second layer; and simultaneously displaying the first layer and the second layer, and allowing the virtual image of the real-time strike zone 3D image to be located over the home plate. For instance, the second layer is displayed on the first layer.

For instance, in the method for assisting in judging a strike provided by an example of the embodiment, the step of simultaneously displaying the first layer and the second layer includes: setting the transparency of the second layer to be 10%-90%, so as to allow the first layer beneath the second layer to be viewed through the second layer. The embodiments of the present disclosure include but are not limited thereto. The first layer may also be displayed on the second layer, and the transparency of the first layer is set to be 10%-90%.

Many functional components/parts described in the description are all called units in order to more particularly emphasize the independence of implementation.

In the embodiments of the present disclosure, the units may be achieved by software so as to be executed by various types of processors. For example, a marked executable code unit may include one or more physical or logical blocks of a computer instruction, and for instance, may be constructed as an object, a procedure or a function. Even so, executable codes of the marked unit are not required to be physically located together but may include different instructions stored on different physical blocks. When the instructions are logically combined, a unit is constructed and the predetermined object of the unit is achieved.

Actually, the executable code unit may include a single instruction or many instructions which may even be distributed on a plurality of different code segments, distributed in different programs, and distributed on a plurality of storage devices. Similarly, operational data may be identified in the unit, achieved by any appropriate means and organized in any appropriate type of data structure. The operational data may be collected as a single data set or may be distributed at different positions (including the instance of being distributed on different storage devices) and may at least partially exist on a system or a network by being only taken as electronic signals.

When the unit can be achieved by software, in view of the level of the traditional hardware technology, those skilled in the art can establish corresponding hardware circuits on units capable of being achieved by software to achieve corresponding functions regardless of the cost. The hardware circuits include conventional very large scale integration (VLSI) circuits or gate arrays and conventional semiconductors, such as logic chips and transistors, or other discrete elements. The unit may also be achieved by programmable hardware units, such as field programmable gate arrays, programmable logic arrays, or programmable logical devices.

The following points should be noted:

(1) The accompanying drawings in the embodiments of the present disclosure only involve structures relevant to the embodiments of the present disclosure, and other structures may refer to common design(s).

(2) Without conflict with each other, the features in different embodiments, or the same embodiment of the present disclosure may be combined.

The described above are only exemplary embodiments of the present disclosure, and the present disclosure is not limited thereto. For one of ordinary skill in the art, various changes and alternations may be readily contemplated without departing from the technical scope of the present disclosure, and all of these changes and alternations shall fall within the scope of the present disclosure.

What is claimed is:

1. An intelligent baseball device, comprising:
a depth camera configured to acquire a depth image of a home plate and a batter;
a display device configured to display an image according to a display signal; and
a processing unit,
wherein the depth camera is communicated with the processing unit; the processing unit is configured to extract feature information of the home plate and feature information of the batter from the depth image and create a real-time strike zone 3D model; the display device is communicated with the processing unit; the processing unit is configured to send a display signal of the real-time strike zone 3D model to the display device; and the display device displays the real-time strike zone 3D model according to the display signal of the real-time strike zone 3D model.

2. The intelligent baseball device according to claim 1, wherein the processing unit is also configured to calculate the relative positional relationship between the display device and the home plate, and map the relative positional relationship into the real-time strike zone 3D model, to allow a virtual image of the real-time strike zone 3D model to be located over the home plate.

3. The intelligent baseball device according to claim 2, wherein the display device includes a transparent display device.

4. The intelligent baseball device according to claim 2, wherein the display device includes:
a transflective member; and
a projector,
wherein the projector is configured to project the real-time strike zone 3D model onto the transflective member according to the display signal of the real-time strike zone 3D model; and the transflective member is configured to reflect the real-time strike zone 3D model.

5. The intelligent baseball device according to claim 4, wherein the transflective member includes semi-transmissive glasses.

6. The intelligent baseball device according to claim 1, wherein the depth camera is also configured to acquire an image of a realistic scene; the processing unit is configured to process the image of the realistic scene to be a first layer, and acquire position information of the home plate and the batter in the first layer, position the real-time strike zone 3D model according to the position information of the home plate and the batter in the first layer and form a second layer; and the display device is configured to simultaneously display the first layer and the second layer, to allow the virtual image of the real-time strike zone 3D model to be located over the home plate.

7. The intelligent baseball device according to claim 6, wherein the second layer has a transparency in a range of 10%-90%.

8. The intelligent baseball device according to claim 1, wherein the processing unit includes:
an image processing unit configured to process the depth image and extract the feature information of the home plate and the feature information of the batter from the depth image;
a model storage unit configured to store a standard 3D model; and
a model generation unit configured to map the feature information of the home plate and the feature information of the batter onto the standard 3D model to create the real-time strike zone 3D model.

9. The intelligent baseball device according to claim 1, wherein the feature information of the home plate includes position information of five vertexes of the home plate.

10. The intelligent baseball device according to claim 1, wherein the feature information of the batter includes position information of the shoulder joint and the knee joint of the batter.

11. The intelligent baseball device according to claim 2, wherein the processing unit includes:
an image processing unit configured to process the depth image and extract the feature information of the home plate and the feature information of the batter from the depth image;
a model storage unit configured to store a standard 3D model; and
a model generation unit configured to map the feature information of the home plate and the feature information of the batter onto the standard 3D model to create the real-time strike zone 3D model.

12. The intelligent baseball device according to claim 11, wherein the feature information of the home plate includes position information of five vertexes of the home plate.

13. The intelligent baseball device according to claim 12, wherein the feature information of the batter includes position information of the shoulder joint and the knee joint of the batter.

14. An intelligent baseball helmet, comprising:
a helmet body; and
an intelligent baseball device disposed on the helmet body,
wherein the intelligent baseball device includes the intelligent baseball device according to claim 1.

15. A method for assisting in judging a strike, comprising:
acquiring a depth image of a home plate and a batter;
extracting feature information of the home plate and feature information of the batter from the depth image;
creating a real-time strike zone 3D model according to the feature information of the home plate and the feature information of the batter;
displaying the real-time strike zone 3D model and allowing a virtual image of the real-time strike zone 3D model to be located over the home plate; and
determining whether a pitch is a strike when the pitched ball passes through the virtual image of the real-time strike zone 3D model.

16. The method for assisting in judging a strike according to claim 15, wherein the displaying of the real-time strike zone 3D model and allowing the virtual image of the real-time strike zone 3D model to be located over the home plate includes:
acquiring the relative positional relationship between the display device and the home plate; and
mapping the relative positional relationship into the real-time strike zone 3D model so as to form the virtual image of the real-time strike zone 3D model over the home plate.

17. The method for assisting in judging a strike according to claim 15, wherein the displaying of the real-time strike zone 3D model and allowing the virtual image of the real-time strike zone 3D model to be located over the home plate includes:
acquiring an image of a realistic scene to be a first layer;
acquiring position information of the home plate and the batter in the first layer;
positioning the real-time strike zone 3D model according to the position information of the home plate and the batter in the first layer, and forming a second layer; and
simultaneously displaying the first layer and the second layer so as to form the virtual image of the real-time strike zone 3D model over the home plate.

18. The method for assisting in judging a strike according to claim 15, wherein the simultaneously displaying of the first layer and the second layer includes:
setting the transparency of the second layer to be 10%-90%.
